(19) United States
(12) Patent Application Publication
(10) Pub. No.: US 2026/0222655 A1
(43) Pub. Date: Jul. 30, 2026

(54) AN INFORMATION PROCESSING DEVICE, METHOD AND COMPUTER PROGRAM

(71) Applicant: Sony Group Corporation, Tokyo (JP)

(72) Inventor: Nicolas Pierre ROSE, Basingstoke (GB)

(21) Appl. No.: 19/148,589

(22) PCT Filed: Jan. 26, 2024
(86) PCT No.: PCT/EP2024/051977

§ 371 Date: Jul. 16, 2025

(30) Foreign Application Priority Data
Jan. 30, 2023 (GB) 2301307.1

(51) Int. Cl. H04N 21/485; H04N 21/442; H04N 21/466

(52) U.S. Cl. CPC H04N 21/485; H04N 21/44222; H04N 21/4666

(57) ABSTRACT

An information processing device is provided, comprising: a display control unit configured to control an audio-visual display device to provide audio-visual content to a user; a storage unit configured to store one or more functions which can be activated by the information processing device to adapt the production of audio-visual content; a control unit configured to use a trained model to determine to activate at least one of the one or more functions of the information processing device in accordance with a received user input and a configuration of the information processing device; and a processing unit configured to: monitor usage of the information processing device by the user, including monitoring usage of the one or more functions of the information processing device; determine a level of interest in the one or more functions of the information processing device in accordance with the monitored usage of the information processing device; and adapt the configuration of the information processing device, wherein adapting the configuration of the information processing device includes adapting a decision threshold of the trained model for determining a function to activate on the basis of the determined level of interest.

### BACKGROUND OF THE DISCLOSURE

### Field of the Disclosure

The present invention relates to an information processing device, method and computer program.

### Description of the Related Art

The “background” description provided herein is for the purpose of generally presenting the context of the disclosure. Work of the presently named inventors, to the extent it is described in the background section, as well as aspects of the description which may not otherwise qualify as prior art at the time of filing, are neither expressly or impliedly admitted as prior art against the present invention.

Audio-visual display devices are used in order to provide a user with audio/video content. For example, a user may use an audio-visual display device to consume content generated by a computing device. As a further example, a user may use an audio-visual display device to consume content such as a movie (film), a television program or the like. Examples of consuming include capturing or replaying content.

A number of functions are provided which enable a user to adapt the content produced by an audio-visual display device. For example, an audio-visual display device may have a function to change the brightness of an image displayed by the audio-visual display device. Alternatively, an audio-visual display device may have a function to display subtitles or captions to accompany an image displayed on the display device.

However, in view of the complexity of audio-visual display devices it can be difficult for a user to accurately control functions of the audio-visual display device in order to adapt the content produced by the audio-visual display device. This problem is often exacerbated for a user with reduced mobility, reduced dexterity, or a user with an audio/visual impairment or for a user with a cognitive impairment.

It is an aim of the present disclosure to address these issues.

### SUMMARY

A brief summary about the present disclosure is provided hereinafter to provide basic understanding related to certain aspects of the present disclosure.

The disclosure is defined by the independent claims.

Further respective aspects and features of the disclosure are defined in the appended claims.

In accordance with embodiments of the present disclosure, more accurate control to adapt display of content produced by an audio-visual display device can be achieved with reduced complexity of operation. This reduces frustration of the user when trying to adapt the content produced by the audio-visual display device and ensures that audio-visual content can be more easily accessible for all users—including users with reduced mobility, dexterity, an audio/visual impairment and/or cognitive impairment.

It will be appreciated that the present disclosure is not particularly limited to this advantageous technical effect. Other advantageous technical effects will become apparent to the skilled person when reading the disclosure.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 illustrates an example information processing apparatus according to embodiments of the disclosure;

FIG. 2 illustrates an example situation to which embodiments of the disclosure can be applied;

FIG. 3 illustrates an example configuration of an information processing device in accordance with embodiments of the disclosure;

FIG. 4 illustrates an example configuration of an information processing device in accordance with embodiments of the disclosure;

FIG. 5 illustrates an example system in accordance with embodiments of the disclosure;

FIG. 6A illustrates an example of changing a configuration in accordance with embodiments of the disclosure;

FIG. 6B illustrates an example of a voice instruction in accordance with embodiments of the disclosure;

FIG. 7 illustrates an example of changing a configuration in accordance with embodiments of the disclosure;

FIG. 8 illustrates an example method in accordance with embodiments of the disclosure; and

FIG. 9 illustrates an example of adapting the configuration of an information processing device in accordance with embodiments of the disclosure.

### DESCRIPTION OF THE EMBODIMENTS

The foregoing paragraphs have been provided by way of general introduction, and are not intended to limit the scope of the following claims. The described embodiments, together with further advantages, will be best understood by reference to the following detailed description taken in conjunction with the accompanying drawings (wherein like reference numerals designate identical or corresponding parts throughout the several views).

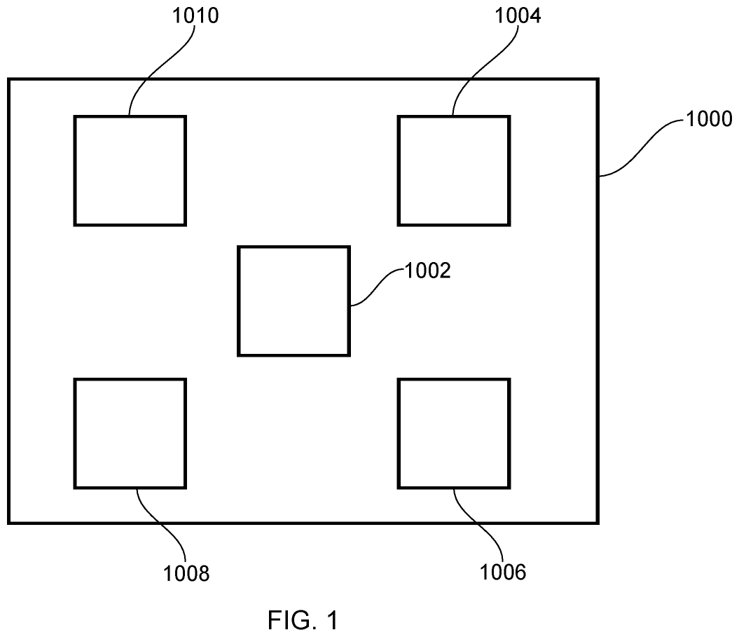

Turning to FIG. 1 of the present disclosure, an example information processing apparatus according to embodiments of the disclosure is illustrated.

Specifically, an apparatus 1000 (an example of an information processing apparatus) according to embodiments of the disclosure is shown. Typically, an apparatus 1000 according to embodiments of the disclosure is a computer device such as a personal computer, an entertainment system or a terminal connected to a server. Indeed, in embodiments, the apparatus may also be a server. The apparatus 1000 is controlled using a microprocessor or other processing circuitry 1002. In some examples, the apparatus 1000 may be a portable computing device such as a mobile phone, laptop computer or tablet computing device.

The processing circuitry 1002 may be a microprocessor carrying out computer instructions or may be an Application Specific Integrated Circuit. The computer instructions are stored on storage medium 1004 which maybe a magnetically readable medium, optically readable medium or solid state type circuitry. The storage medium 1004 may be integrated into the apparatus 1000 or may be separate to the apparatus 1000 and connected thereto using either a wired or wireless connection. The computer instructions may be embodied as computer software that contains computer readable code which, when loaded onto the processor circuitry 1002, from a non-transitory storage medium configures the processor circuitry 1002 to perform a method according to embodiments of the disclosure.

Additionally, an optional user input device 1006 is shown connected to the processing circuitry 1002. The user input device 1006 may be a touch screen or may be a mouse or stylist type input device. The user input device 1006 may also be a keyboard, controller, or any combination of these devices. Furthermore, the input device 1006 may be an audio input device such as microphone or the like which can receive audio instructions (sounds, speech or the like) which are provided by the user.

A network connection 1008 may optionally be coupled to the processor circuitry 1002. The network connection 1008 may be a connection to a Local Area Network or a Wide Area Network such as the Internet or a Virtual Private Network or the like. The network connection 1008 may be connected to a server allowing the processor circuitry 1002 to communicate with another apparatus in order to obtain or provide relevant data. The network connection 1008 may be behind a firewall or some other form of network security. The network connection may be wired or wireless.

Additionally, shown coupled to the processing circuitry 1002, is a display device 1010. The display device 1010, although shown integrated into the apparatus 1000, may additionally be separate to the apparatus 1000 and may be a monitor or some kind of device allowing the user to visualise the operation of the system (e.g. a display screen or a head mounted display). In addition, the display device 1010 may be a printer, volumetric display, projector or some other device allowing relevant information generated by the apparatus 1000 to be viewed by the user or by a third party.

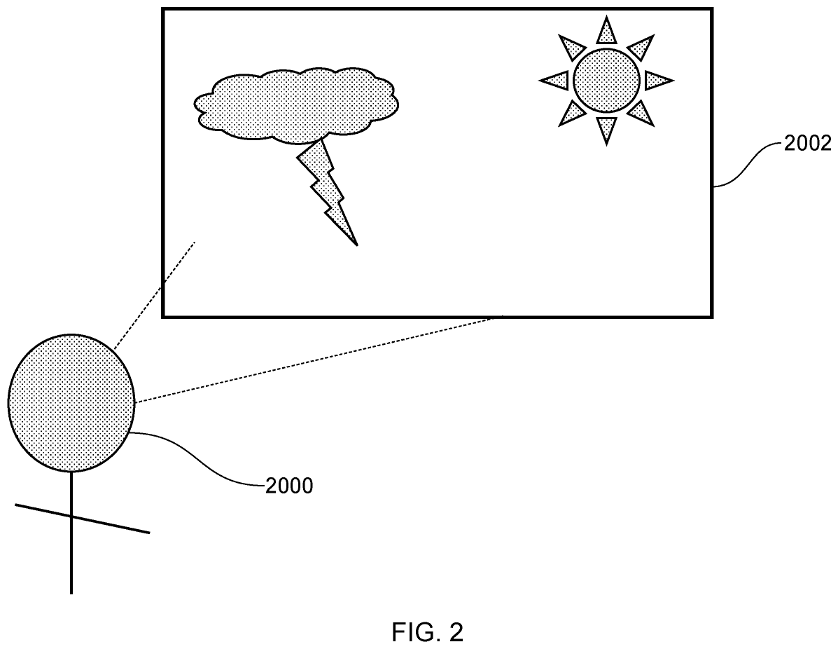

Turning now to FIG. 2 of the present disclosure, an example situation to which embodiments of the disclosure can be applied is illustrated.

In this example, a user 2000 is consuming audio-visual content produced by an audio-visual display device 2002.

Specifically, in this example, the audio-visual display device 2002 is a television. The television may have a visual display panel or screen which displays images that can be seen by the user 2000. These images may be high-definition images. Alternatively, these images may be ultra-high resolution images (such as 4K or 8K images). The television may also include a speaker which can generate sounds that can be heard by the user 2000. Therefore, the television 2002 is a type of audio-visual display device. Content may be replayed from local storage, be streamed via the network connection, received from a radio frequency broadcast or received point to point via radio frequency transmission. Circuitry of the television may be provided separately to the visual display panel and the circuitry may communicate with the panel wirelessly.

In this example, the user 2000 is using the television 2002 to view a movie (film). That is, the television display screen shows the images of the movie and the television speaker generates the audio content of the movie. The user 2000 can therefore watch and listen to the movie on the television 2002.

Now, in this example, the user 2000 may have difficulty hearing the sound generated by the television 2002. That is, the user 2000 may have an auditory impairment, which makes it more difficult for them to hear the sound generated by the television 2002. As such, the user 2000 may wish to use one or more functions of the television 2002 to make it easier for them to enjoy the movie. For example, the user may wish to use one or more accessibility functions on the television, which make the content more accessible for a person with an auditory impairment.

An example of an accessibility function of the television which makes the content more accessible for a person with an auditory impairment is captions (such as closed captions). Captions are text content which is displayed on the television display screen alongside the image of the movie and which provide additional information for the user 2000. For example, the captions may include text such as a transcript of an audio portion of the movie. Therefore, captions enable the user 2000 to more easily understand the audio portion of the movie (such as words spoken by actors within the movie or some other audio commentary track) even if they have difficulty hearing the sound generated by the television 2002.

In some embodiments of the disclosure, subtitles may be used as a type of accessibility function. Subtitles are text content which is displayed on the television screen alongside the image of the movie. In some examples, subtitles may be used to display text in a different language (for example, English) to the language in which the audio is spoken (for example, French). However, in other examples, subtitles may be the same as captions and may include text content which is displayed on the television display screen alongside the image of the movie to provide additional information for the user 2000 (and thus enable the user 2000 to more easily understand the audio portion of the movie, even if they have difficulty hearing the sound which has been generated).

Alternatively, an accessibility function of the television which makes the content more accessible for a person with an auditory impairment is a sign language video. A sign language video is a small video which is displayed alongside the main images of the movie on the television. The sign language video shows a person who uses sign language (a visual means of communicating using gestures, facial expressions and body language) in order to provide a description of an audio portion of the movie. Therefore, a sign language video displayed on the display screen during the movie enables the user 2000 to more easily understand the audio portion of the movie (such as words spoken by actors within the movie) even if they have difficulty hearing the sound generated by the television 2002. The small video may be a sub-stream or a related stream or be incorporated within the video such that there are multiple versions of a video item, for example, a sign language version and one without.

However, there are many different options and functions on an audio-visual display device such as the television 2002. A function which is desired by a user (such as captions) may be located deep within a menu structure. Therefore, it can be difficult for the user to activate a desired function of the audio-visual display device. In particular, a user with reduced mobility or dexterity or who has an auditory or visual impairment (or cognitive impairment) may find it more difficult to successfully navigate through a complex menu structure of an audio-visual display device in order to activate/execute a desired function (e.g. an accessibility function of the audio-visual display device).

Thus, in view of the complexity of audio-visual display devices it can be difficult for a user to accurately control functions of the audio-visual display device in order to adapt the content produced by the audio-visual display device.

For these reasons, in addition to those reasons described in the Background of the present disclosure, an information processing apparatus, method and computer program are provided.

### <Apparatus>

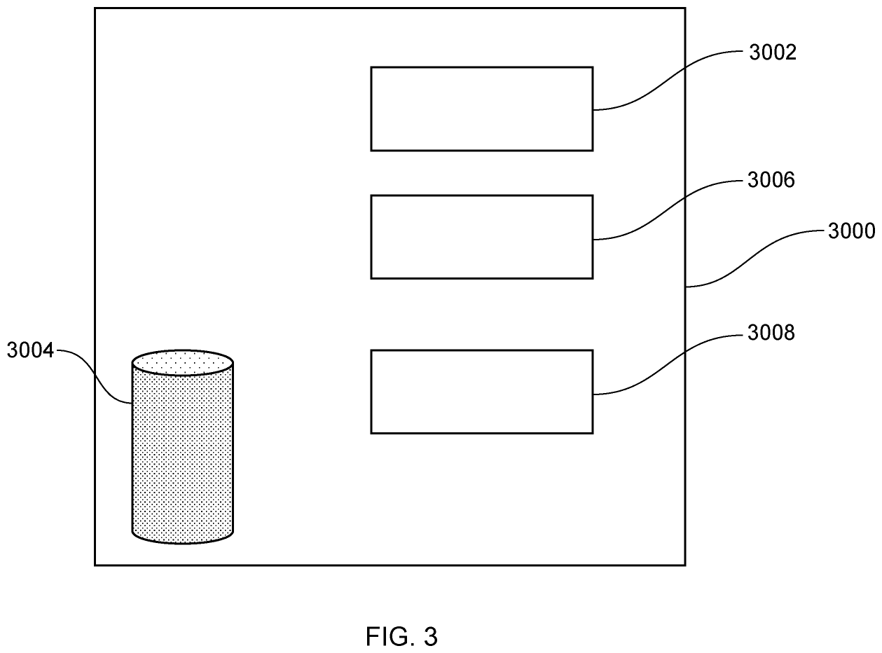

Turning now to FIG. 3 of the present disclosure, an example configuration of an information processing apparatus (or device) according to embodiments of the present disclosure is illustrated.

An information processing apparatus 3000 is illustrated in FIG. 3. The information processing apparatus 3000 comprises a display control unit 3002, a storage unit 3004, a control unit 3006 and a processing unit 3008.

The display control unit 3002 is configured to control an audio-visual display device to provide audio-visual content to a user.

The storage unit 3004 is configured to store one or more functions which can be activated by the information processing device to adapt the provision of audio-visual content by the audio-visual display device. The functions may be activated in response to a user input to select one or more functions.

The control unit 3006 is configured to use a trained model to determine to activate at least one of the one or more functions of the information processing device in accordance with a received user input and a configuration of the information processing device. In some examples, the model is a collection of software code components each representing different elements of the model which can be used for performing a certain task (here, the determination of at least one or more function of the information processing device to activate). Therefore, in some examples, the trained model is a computer program that has been trained to make decisions based on a previously unseen data set. Further details regarding training of the trained model will be described later.

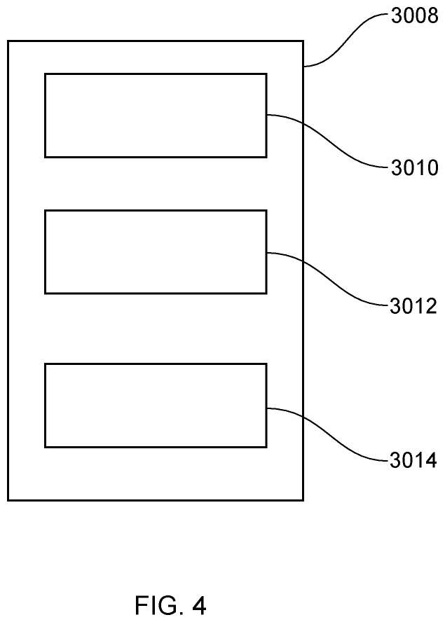

Furthermore, the processing unit 3008 can be configured as illustrated in FIG. 4 of the present disclosure. That is, FIG. 4 illustrates an example configuration of an information processing apparatus (or device) according to embodiments of the present disclosure. In particular, the processing unit 3008 can include a monitoring unit 3010, a determining unit 3012 and an adapting unit 3014.

The monitoring unit 3010 is configured to monitor usage of the information processing device by the user, including monitoring usage of the one or more functions of the information processing device.

The determining unit 3012 is configured to determine a level of interest in the one or more functions of the information processing device in accordance with the monitored usage of the information processing device.

The adapting unit 3014 is configured to adapt the configuration of the information processing device, wherein adapting the configuration of the information processing device includes adapting a decision threshold of the trained model for determining a function to activate on the basis of the determined level of interest.

In this manner, the information processing apparatus 3000 of the present disclosure is able to achieve more accurate control to adapt display of content on an audio-visual display device, with reduced complexity of operation. This reduces frustration of the user and ensures that audio-visual content can be more easily accessible for all users including users with reduced mobility, reduced dexterity, an audio/visual impairment and/or cognitive impairment.

The different units or processing circuitry of the information processing apparatus may be provided in a single apparatus or device. Alternatively, different units or processing circuitry of the information processing device may be distributed over a number of different apparatuses or devices (e.g. as a system). The present disclosure is not particularly limited in this regard.

Furthermore, while described as different units of the information processing apparatus, it will be appreciated that in the display control unit 3002, the storage unit 3004, the control unit 3006 and the processing unit 3008 may, more generally, be implemented as circuitry of the information processing apparatus. Circuitry, whether or not provided as different functional units includes memory having computer executable software stored thereon and/or further computer code components which control the configuration of the computer executable software.

Furthermore, while described as separate from the audio-visual display device, in some examples the information processing device 3000 may be integrated as part of the audio-visual display device and/or provided as part of a system comprising the information processing device 3000 and an audio-visual display device. For example, when the audio-visual display device is a television, the information processing apparatus 3000 may be integrated as part of the television.

Further details of the information processing apparatus of embodiments of the disclosure will now be described.

### <Display Control Unit>

As described with reference to FIG. 3 of the present disclosure, the information processing apparatus 3000 comprises a display control unit 3002. The display control unit 3002 is configured to control an audio-visual display device to provide audio-visual content to a user.

As described with reference to FIG. 2 of the present disclosure, the audio-visual display device may be a television. However, the present disclosure is not particularly limited in this respect. Alternatively, the audio-visual display device may be a computer monitor. Further alternatively, the audio-visual display device may be a portable electronic device which includes a display screen and a speaker and is thus capable of producing audio-visual content. For example, the portable electronic device may include a mobile telephone (smart phone), laptop computing device, tablet computing device or the like. Hence, more generally, the audio-visual display device is any device which is capable of providing audio-visual content to a user.

The display control unit 3002 is communicatively coupled with the audio-visual display device. This may be using any suitable wired or wireless communication. The display control unit 3002 then controls the audio-visual display device in order that the audio-visual display device provides the desired audio-visual content to the user.

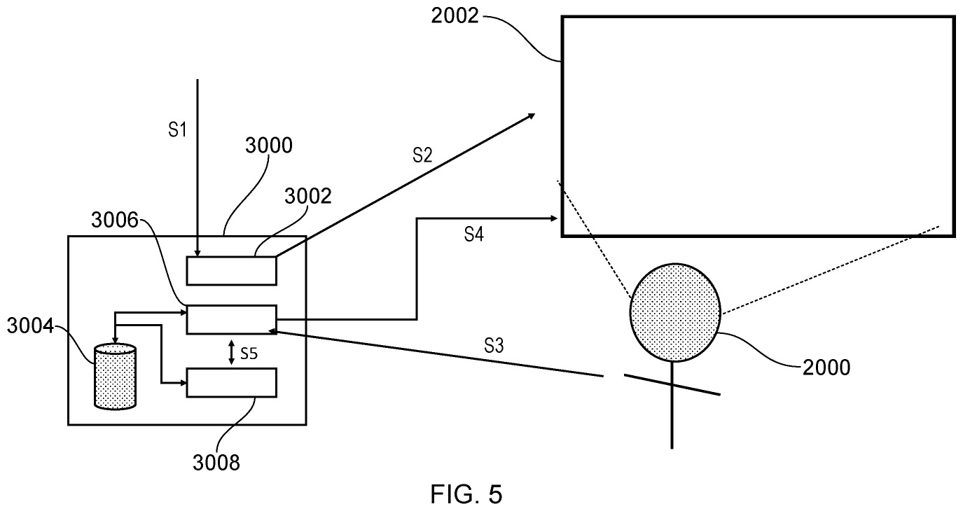

Consider, now, the example of FIG. 5 of the present disclosure. In this example, a user 2000 wishes to watch certain audio-visual content on a television 2002 (the television 2002 being an example of a type of audio-visual display device).

Furthermore, in this example, an information processing apparatus 3000 is provided. The user 2000 can use the information processing apparatus 3000 in order to control the functions of the television 2002. This makes it easier and more accurate for the user to control the functions and operation of the television 2002. For example, the user 2000 can activate certain functions in order to adapt the production of audio-visual content by the audio-visual display device.

As previously noted, the information processing apparatus 3000 comprises a display control unit 3002.

In this example, the display control unit 3002 receives data S1 from a data source and generates a control signal S2 to cause the television 2002 to produce audio-visual content for the user 2000.

In some examples, such as when the audio-visual display device is a television, the display control unit 3002 may be a television tuner, which allows a person to receive signals on their television (such as different programme channels). In this case, the display control unit 3002 may receive data S1 from a data source such as a broadcaster. The tuner then provides the data which has been received to the television 2002 in order to control the television to display audio-visual content corresponding to a selected programme channel.

In other examples, the display control unit 3002 may control the audio-visual display device to provide audio-visual content to a user from one or more other data sources.

For example, the display control unit 3002 may receive data S1 over a network such as the internet from a content delivery network or, more generally, a server. In particular, the display control unit 3002 may receive data from a streaming service and control S2 the television 2002 to provide audio-visual content to a user corresponding to the data received from the streaming service.

Indeed, in some examples, the display control unit 3002 may be implemented as an application on the audio-visual display device which can be used in order to provide a streaming service over the internet to enable a user to watch audio-visual content on the audio-visual display device. Indeed, the application may require a subscription in order that the user can watch certain content on the audio-visual display device. The application may be provided via an app store or portal or other repository of applications available via the internet or via radio frequency communication network.

Further alternatively, the display control unit 3002 may control the audio-visual display device (the television in this example) to produce audio-visual content from an external device (such as a recorder, set-top-box or the like). The display control unit 3002 may receive data S1 from this external device (over any suitable wired or wireless interface) and control S2 the audio-visual display device 2002 to produce corresponding audio-visual content.

In this way, the user 2000 can consume audio-visual content on the audio-visual display device 2002.

### <Storage Unit 3004>

As described with reference to FIG. 3 of the present disclosure, the information processing apparatus 3000 further comprises a storage unit 3004. The storage unit 3004 is configured to store one or more functions which can be activated by the information processing device to adapt the production of audio-visual content.

The storage unit 3004 can be any suitable storage device for storing functions of the audio-visual display device. In some examples, the storage unit 3004 may be a magnetically readable medium, optically readable medium or solid state type circuitry. However, the present disclosure is not particularly limited in this regard.

In some examples (as illustrated in the example of FIG. 5 of the present disclosure) the storage unit 3004 may be integrated as part of the information processing apparatus 3000. Alternatively, the storage unit 3004 may be external to the information processing apparatus 3000. Further alternatively, the storage unit 3004 may be external to the information processing apparatus 3000 and located within the audio-visual display device 2002. The present disclosure is not particularly limited in this regard.

The functions which are stored in the storage unit 3004 are functions which, when activated by the information processing device, adapt the production of audio-visual content by the audio-visual display device 2002.

For example, the functions may include functions to adapt the picture which is produced by the audio-visual display device. These may include functions to adapt the brightness, contrast, sharpness, colour gamut and/or aspect ratio of the picture produced by the audio-visual display device 2002.

Alternatively, or in addition, the functions may include functions to adapt the sound which is produced by the audio-visual display device. These may include functions to adapt the volume of the sound produced by the audio-visual display device. More specifically, the functions may include an audio equalizer function which enables the relative volume of different frequency bands within an audio signal to be adjusted (e.g. a function such as a bass booster or the like, to boost the volume of lower frequency components of the audio signal).

Alternatively, or in addition, the functions may include functions which adapt a number of properties of the audio-visual content produced by the audio-visual display device for a given use of the audio-visual display device. For example, the functions may include a “movie mode” or a “game mode” which can be activated by the user to enhance the audio-visual content produced by the audio-visual display device when the user is watching a movie or playing a game respectively. However, the present disclosure is no particularly limited in this regard, and the functions may include a number of different types of functions in addition to or as an alternative to a “movie mode” and a “game mode”. The sound may be adapted according to content genre described in metadata. The sound may be adapted according to type of device interconnected with the information processing apparatus, for example in accordance with a look up table.

Further alternatively or in addition, the functions may include a number of accessibility functions to adapt the production of audio-visual content by the audio-visual display device 2002. These accessibility functions (or accessibility features) are functions which are designed to help people with disabilities use technology more easily. Therefore, these accessibility functions adapt the production of audio-visual content by the audio-visual display device in order that a person with disabilities can more easily consume audio-visual content produced by the audio-visual display device. This includes adapting the audio-visual content in response to sensors, such as, and not limited to ambient light sensors, movement sensors, sensors detecting the number, identity, activity or position of users or viewers.

As an example, the accessibility functions may include functions to make it easier for a person with an auditory impairment to access the audio-visual content, even if they cannot easily hear the sound which is generated by the audio-visual display device. For example, these accessibility functions to improve accessibility of audio-visual content for a person with an auditory impairment may include captions, subtitles or sign language video. Detailed discussion of accessibility functions such as captions and sign language video have already been provided. Accordingly, further discussion of these features will not be provided at this stage for brevity of disclosure.

As an alternative example, the accessibility functions may also include functions which make it easier for a person with a visual impairment to access the audio-visual content, even if they cannot easily see the image which is generated by the audio-visual display device.

An example of an accessibility function for a user (i.e. any person using the audio-visual display device) with a visual impairment may include an audio description function. Audio description is a form of narration which provides information regarding visual content shown on the audio-visual display device. Therefore, even if the user cannot easily see the picture shown by the audio-visual display device, the user can still understand what is being shown and more easily enjoy the content produced by the audio-visual display device.

Other examples of accessibility functions for a user with a visual impairment include a talking user interface (or voice-user interface) or a Text-To-Speech function, where elements of a user interface shown on the audio-visual display are converted into sound and “read” to the user such that the user can more easily operate the user interface even if they cannot easily see the picture shown by the audio-visual display device. A subtitle in a different language may be “read” to the user. A subtitle in a different language may be “read” to the user in a translated form. A further accessibility function includes a zoom or magnification function. A focus zoom function for example allows a portion of the displayed video to be magnified, for example mimicking a magnifying glass function.

Furthermore, accessibility functions may also include certain functions which make it easier for a person who has language difficulties (e.g. functions which request different language audio streams or different language subtitles) or functions which assist a user who may be less familiar with the use of technology.

As such, it will be appreciated that the storage unit 3004 may store a number of different functions for using features of the audio-visual display device, including accessibility functions for using accessibility features of the audio-visual display device. However, these functions are not particularly limited to the specific functions which have been described. More generally, the storage unit 3004 may store any function which, once activated, adapts the production of audio-visual content by the audio-visual display device 2002.

As previously explained, in some examples, the information processing apparatus 3000 may be incorporated or integrated within the audio-visual display device. In this example, the functions would then be stored in a storage unit of the audio-visual display device.

The present disclosure is therefore not particularly limited in this regard, and the specific functions stored in the storage unit 3004 may vary in accordance with the situation to which embodiments of the disclosure are applied.

### <Control Unit>

Furthermore, the information processing apparatus 3000 comprises a control unit 3006. The control unit 3006 is configured to use a trained model to determine to activate at least one of the one or more functions of the information processing device in accordance with a received user input and a configuration of the information processing device.

As previously explained, the information processing apparatus 3000 (which may be integrated as part of an audio-visual display device) comprises a storage unit 3004 storing a number of functions which can be used to adapt the production of audio-visual content by the audio-visual display device. An example of these functions include accessibility functions which adapt the production of the content in order to enable the user to more easily access audio-visual content on the audio-visual display device, even if they have an auditory or visual impairment.

The inventors have realised that it can be difficult for a user to accurately control functions of the audio-visual display device in order to adapt the content produced by the audio-visual display device. This problem is often exacerbated for a user with reduced mobility, dexterity or a user with an audio/visual impairment or cognitive impairment.

Accordingly, embodiments of the disclosure provide control unit configured to use a trained model to determine to activate at least one of the one or more functions stored in the storage unit. In some examples, the trained model may include a trained model which enables the user to perform voice control (i.e. enables the user to activate certain functions through speech). However, the present disclosure is not particularly limited in this regard. More generally, the trained model may employ AI decision making to any suitable input provided by the user in order to determine activation of the one or more functions.

Moreover, in accordance with embodiments of the disclosure, the decision threshold of the trained model for determining a function to activate is adapted on the basis of a determined level of interest of the user in a certain function or set of functions. For example, if a user frequently uses a function such as subtitles, then the trained model will be adapted in order that it is easier for the user to activate the subtitles function. This makes it easier for a user to more accurately control adaptation of the display of content on an audio-visual display device, reducing frustration of the user and ensuring that audio-visual content can be more easily accessible for all users (including users with reduced mobility, reduced dexterity, an audio/visual impairment and/or cognitive impairment). Whilst subtitles may be easy to actuate on some devices, for example from a dedicated key on a remote control, selection of specific settings such as size font, colour background colour, position may be more complex. A user may require a specific combination of settings. The requirement may vary depending on the content—for example a black subtitle background in movie with dark images is likely to be undesirable even if it is a user's general preference for normal viewing (for example for a typical news bulletin). The requirements of a colour blind user may be very specific in terms of font/background colour. Adaption of the decision threshold of the trained model will be described in more detail below.

However, first, initial training of the trained model will be described.

The trained model used by the control unit to determine whether to activate at least one of the one or more functions stored in the storage unit can include a machine learning model. The machine learning model can be trained using either supervised learning or unsupervised learning. In some examples, the machine learning model may, specifically, be a deep learning model which utilizes neural networks.

In supervised learning, labelled data is provided to the machine learning model. That is, data is provided as both an input and a corresponding output. The machine learning model is then trained on this labelled data such that it can be used to predict the output for previously unseen input data.

As a specific example, training a model to determine to activate at least one or the one or more functions stored in the storage data can require the use of training data. Training data can be obtained from historical data regarding the use of functions by users. Alternatively, training data can be simulated data regarding the use of functions by users.

The training data includes as input the user inputs (e.g. a voice command, button press, gesture or the like) provided by the user and the configuration of the audio-visual display device at that time (e.g. a current application used on the audio-visual display device, a type of content being produced on the audio-visual display device (such as a movie or a videogame) a status of the audio-visual display device (e.g. how long the audio-visual display device has been displaying audio-visual content) or the like). The training data includes as output the function which is activated by the user corresponding to the user inputs and the configuration of the audio-visual display device (e.g. whether the user activated a function such as an accessibility function (such as captions, subtitles or the like).

The training data is not limited to this specific example of training data and different inputs and outputs can be provided in the training data depending on the situation to which the embodiments of the disclosure are to be applied.

The training data, once acquired, is then split into two data sets. These data sets include a training data set and a test data set.

The model (such as a machine learning model) is then trained using the training data set portion of the training data. This enables the model to learn a correspondence between the inputs (i.e. the user input and the configuration of the audio-visual display device) and the output (i.e. the function to activate).

Once trained on the training data set portion of the training data, the performance of the trained model can then be evaluated. That is, the trained model is provided with the (previously unseen) inputs from the test data set and predicts the outputs from these inputs (i.e. the function to activate). The output predicted by the trained model can then be compared with the (previously unseen) output from the test data set in order to evaluate the performance of the trained model.

Additional training with additional training data (of the same form described above) can then be performed, if required, until satisfactory performance of the trained model on the test data is achieved.

The present disclosure is not particularly limited to the use of supervised learning when training the trained model. Instead, unsupervised learning can be used to train the trained model. Here, the same training data is provided to the model (e.g. a machine learning model) but the data are not labelled. Instead, the model analyses the data in order to discover patterns in the data to discover the innate structure of the unsalable data. This enables the model to learn for any given inputs (that is, the user input and configuration of the audio-visual display device) what corresponding function should be activated.

In this way, a trained model can be acquired which can then be used by the controlling unit 3006 of the information processing apparatus 3000 in order to determine to activate at least one of the one or more functions of the information processing device in accordance with a received user input and a configuration of the information processing device.

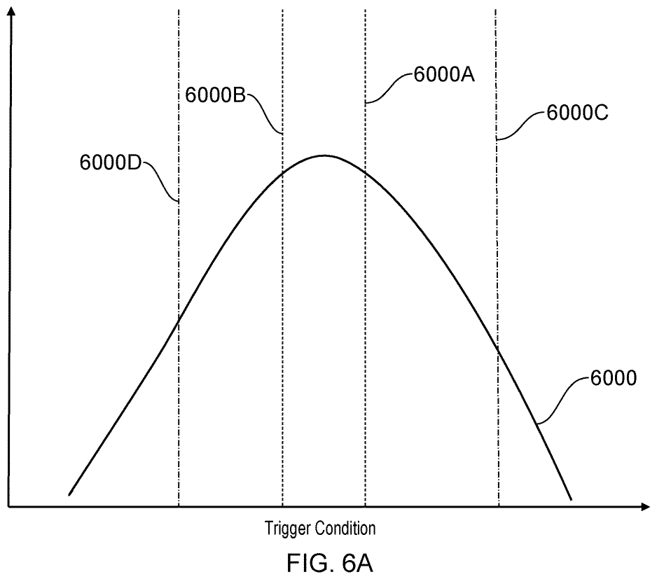

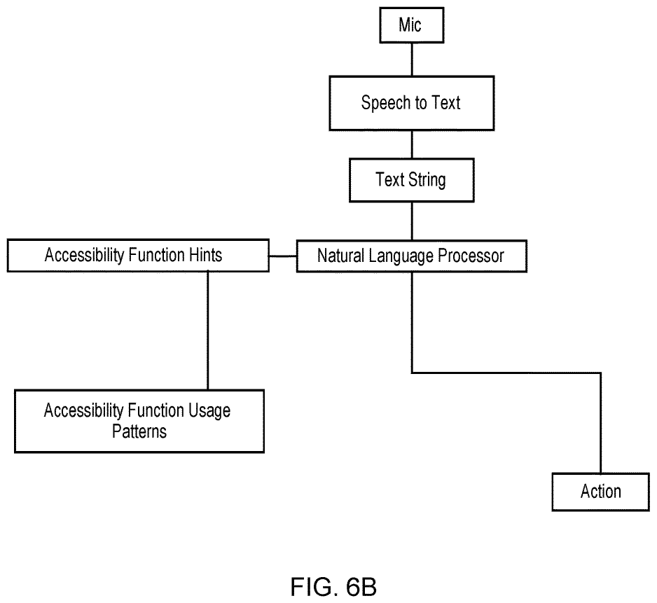

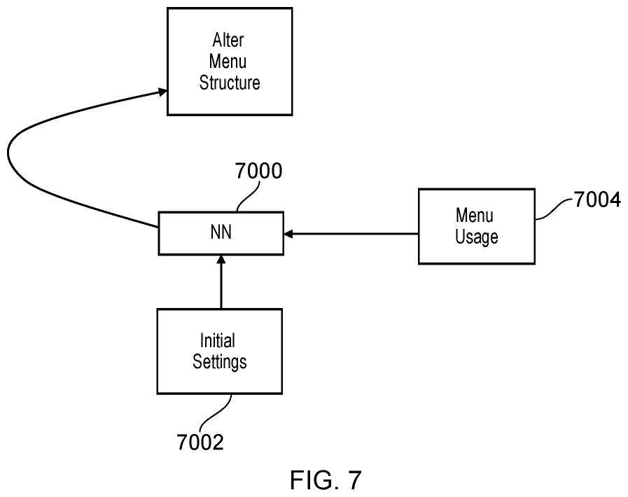

The initial training of the trained model thus trains the trained model to be able to determine which function of the set of functions should be activated based on the operation of the user. However, since the initial training of the trained model is based on operations performed by a range of users, it may not be specifically tailored to the individual requirements of a user. Therefore, the monitoring unit 3010, determining unit 3012 and adapting unit 3014 of the information processing apparatus 3000 adapt the configuration of the information processing device (including the decision thresholds of the trained model) to more specifically adjust the trained model for the requirements of the user. This will be described later in more detail with reference to FIGS. 6A, 6B and 7 of the present disclosure.

Consider, again, the example illustrated with reference to FIG. 5 of the present disclosure. In this example, a user 2000 is watching audio-video content produced by an audio-visual display device 2002. The user 2000 uses the information processing apparatus 3000 to control one or more functions of the audio-visual display device.

In particular, the user 2000 who is watching the content produced by the audio-visual display device 2002 may be a user with an auditory impairment. Therefore, it may be difficult for the user 2000 to hear the sound which is produced by the audio-visual display device. As such, the user 2000 may wish to activate an accessibility function of the audio-visual display device (such as captions or subtitles) which will make it easier for the user to understand the audio content being produced by the audio-visual display device—even if they cannot easily hear the sound which is being produced.

As such, the user 2000 may provide an input instruction S3 to activate a desired function of the audio-visual display device. For example, the user may provide a voice instruction to activate a desired function of the audio-visual display device. Alternatively, the user 2000 may provide an input instruction using any type of user input device such as user input device 1006 described with reference to FIG. 1 of the present disclosure (e.g. by using a user input device to select certain options from a menu in a graphical user interface).

In this example, the user input instruction S3 is provided directly to the control unit 3006 of information processing apparatus 3000. However, in other examples (such as when information processing apparatus 3000 is integrated in the audio-visual display device), the user input instruction S3 may be received by the audio-visual display device and passed to the control unit 3006 of apparatus 3000.

In addition, the control unit 3006 may receive information concerning the configuration of the audio-visual display device. The configuration of the audio-visual display device can include any contextual information concerning the current status of the audio-visual display device (such as a current application being utilized by the audio-visual display device, a type of content being watched on the audio-visual display device, a menu or user interface currently displayed by the audio-visual display device or the like). This information may be received by the control unit 3006 from the audio-visual display device.

Upon receiving the user input instruction S3 and the information concerning the configuration of the audio-visual display device, the control unit 3006 may then utilize the trained model in order to determine a function of the one or more functions stored in the storage unit 3004.

Then, once activated, the function will adapt the production of audio-visual content on the audio-visual display S4. For example, when the user requests subtitles, the control unit will activate a function and adapt the display of the image on the audio-visual display device such that subtitles are shown on the audio-visual display device.

In examples of the disclosure, when the control unit activates a function, that function immediately adapts the production of audio-visual content on the audio-visual display. However, in other examples, execution of a function causes a message seeking confirmation of the user's intention to be provided to the user (being either an audible or visual confirmation message). The function will then only be executed if the user confirms this intention. Confirmation can be provided by an additional user input. Alternatively, confirmation can be provided by an absence of a user input within a period of time (e.g. if the user does not cancel the activation of the function within a predetermined time period). This enables the control unit to offer or suggest a function to the user before that function is executed.

Therefore some examples, the control unit 3006 of the information processing apparatus 3000 may use the trained model in order to determine to whether or not a function should be offered to a user (e.g. depending on the context of the use). For example, if a user is playing a certain type of content on the audio-visual display device (e.g. a movie) or if the user is using a certain type of application to stream content on the audio-visual display device, then the information processing apparatus 3000 may use the trained model in order to identify that a certain function (e.g. subtitles) should be activated and offered to the user. The user may then determine whether or not to execute this function (and thus display subtitles on the display). By activating a function in this manner in order to offer the function to the user, control of the device is further improved.

In this way, the control unit 3006 may use a trained model to interpret the input provided by a user based on the context of its use (i.e. in view of the configuration of the audio-visual display device) in order to determine a function of the one or more functions stored in the storage unit 3004 to execute (or activate). This makes it easier for a user to control the audio-visual display device.

### <Monitoring Unit>

As explained with reference to FIG. 3 of the present disclosure, the information processing apparatus 3000 may further comprises a monitoring unit 3010. The monitoring unit 3010 may be part of processing circuitry 3008 of the information processing apparatus 3000. Furthermore, the monitoring unit 3010 may be configured to monitor usage of the information processing device by the user, including monitoring usage of the one or more functions of the information processing device.

Indeed, it will be appreciated that there are a number of different functions which may be stored in the storage unit 3006 of the apparatus 3000 which can be used to adapt the production of audio-visual content on the display device. Some of these functions may be used quite often by a user. However, other functions may be used very rarely by the user—if the user uses these functions at all. Moreover, the relative usage of the functions stored in the storage unit may vary between users of the audio-visual display device. For example, a user with a visual impairment may frequently require use of a function such as Audio Description, while a user with an auditory impairment may rarely use an Audio Description function at all. This makes it difficult for a trained model to decide when to activate a given function, as the relative usage of the functions may change significantly between users.

As such, in the present disclosure, the monitoring unit 3010 of information processing apparatus 3000 monitors the usage of the functions by the user. Therefore, even if the trained model has been trained on training data from a plurality of different users, the information processing apparatus can adapt the decision threshold (sensitivity) for different functions of that trained model in order to account for the different relative usage of those functions by individual users. In other words, the inventors have realised that the configuration of the information processing apparatus 3000 (including the decision thresholds of the trained model) should be adapted to account for the different requirements of individual users. This enables a user to more easily and accurately control the functions of the device.

In some examples, the usage of the functions can include the frequency of use of a function (or functions). For example the monitoring unit 3010 can monitor how often a given function of the one or more functions stored in the storage unit is activated by a user within a given period of time (e.g. over the course of a day, week, month or the like).

As such, in examples, if such functions are often chosen by the user (above a frequency threshold—and optionally if they take a long time for an individual user to set up), then certain configuration actions may be taken automatically to make it easier for the user to activate those functions.

Alternatively or in addition, in other examples, the monitoring unit 3010 can monitor a context of use for each function of the one or more functions. That is, a user may require use of a certain function (such as captions or subtitles) frequently when they are watching a movie on the audio-visual display device; on the other hand, that same user may user the same function (such as captions or subtitles) very rarely when they are playing a videogame on the audio-visual display device. Therefore, by monitoring the context in which a function is activated by a user (including, for example, a type of content being watched on the audio-visual display device at the time at which the function is activated by the user) a greater understanding of the individual requirements of the user can be attained.

The context of use is not limited specifically to the type of content being watched on the audio-visual display device at the time when the function is activated by the user. Instead, in some examples, the context of use may include other factors such as a location of the user at the time when the function was activated by the user (e.g. when the user is using a portable audio-visual display device, the user may require certain functions more frequently when in certain locations).

Alternatively or in addition, in other examples, the monitoring unit 3010 may monitor a time of use of a function by the user. That is, a certain user may require use of a function (such as captions or subtitles) more frequently in the evening than in the morning. Therefore, by monitoring the time at which a function is activated by a user, a greater understand of the individual requirements of the user can be attained.

Alternatively or in addition, in other examples, the monitoring unit 3010 may monitor the difficulty of use by the user for a given function or set of functions. If a user finds a given function very difficult to activate, then that user may require additional help when seeking to activate that given function. The user may find a function difficult to activate if they cannot find the option to activate that function in a menu. Alternatively, the user may find a function difficult to activate if they cannot remember the activation keyword (trigger) which is to be provided as an audio command in order to activate that function. Therefore, monitoring the difficulty the user has in the activation of a given function enables a greater understanding of the individual requirements of the user to be attained.

In embodiments of the disclosure, the difficulty the user experiences when trying to activate a given function (the difficulty of use by the user) can be monitored by the monitoring unit 3010 in a number of different ways. For example, the difficulty of use can be monitored by the number of received user inputs prior to execution of a function; if the user cannot remember the activation keyword (trigger) which is to be provided as an audio command in order to activate a desired function, they may try several different words (as audio commands) prior to using the correct activation keyword. Thus, the number of received user inputs prior to execution of the function can indicate the difficulty the user experiences when trying to activate a given function. The received inputs may be activation followed by immediate deactivation of a particular function.

As a specific example, consider again the situation described with reference to FIG. 5 of the present disclosure. In this example, a user 2000 is using an information processing apparatus 3000 to control functions to adapt the provision of content on the audio-visual display device 2002.

Specifically, in this example, the user may wish to activate a function to display subtitles on the display screen. However, the user may not remember that the activation keyword for the subtitles function is “Subtitles” (as described in manual or user guide or the like). Instead, the user may first provide audio commands of, “Text”, “Description”, “Writing” and “Subs” or use words in their mother tongue before they provide the correct activation keyword of “Subtitles”. Accordingly, the monitoring unit 3010 of the present disclosure can monitor that five input instructions were provided by the user prior to activation of the subtitles function. This demonstrates that the user had difficulty in activating the subtitles function (as a number of inaccurate instructions were provided before the intended function was activated).

The number of input instructions provided before activation of a function as an indicator of the difficulty of use of that function is not particularly limited to the situation whereby the input instructions are provided as audio commands. Alternatively or in addition, the number of input instructions before activation of a function can also be used as an indicator of the difficulty of use of that function when the user provides the input instructions by a different mechanism such as by operation of a user input device (such as a remote control device or the like). For example, if the user has to navigate through many different options or layers of a menu to activate a function, they will provide several input instructions (e.g. button presses) before activating the desired function.

Therefore, by monitoring the number of input instructions provided by a user before activation of a function, the difficulty the user experiences in activation of a function can be assessed.

Furthermore, the difficulty the user experiences in activation of a function can also be assessed, alternatively or in addition, based upon the time duration from an initial user input prior to execution of a function to the execution of the function.

As an example, when a user is watching content on an audio-visual display device, they may wish to activate a function (such as captions or subtitles). Therefore, the user may provide an initial user input instruction to open a control menu or the like from which the desired function can be selected. Here, an initial input instruction is an input instruction which is the first input instruction to have been received after a predetermined interval of time or an input instruction which performs a first input of a sequence (e.g. opening a control menu).

Then, once this initial input instruction has been provided, the monitoring unit 3010 can monitor how long it takes before the user activates a function. The longer the time duration between the initial input instruction and the activation of the function, the more difficulty it can be determined that the user has experienced in the activation of that function.

The difficulty of activation of a function can also be assessed in a number of different ways, including, for example, how frequently a user toggles a function on and off; if a user tries to activate a function, but activates a different function by mistake, then the user will likely cancel the activation of the function once they realise that an incorrect function has been activated by mistake. Accordingly, by monitoring how frequently the user toggles a function on and off (or how quickly a user cancels a function once it has been activated) the difficulty in activation of a function can be assessed. An example may be activation, allowing previewing of certain functionality followed by deactivation.

In this manner, the monitoring unit 3010 of the information processing apparatus 3000 is configured to monitor the difficulty of use of the function.

It will be appreciated that the usage of the functions as monitored by the monitoring unit 3010 may be performed individually for each function of the one or more functions stored in the storage unit 3006 of information processing apparatus 3000. Moreover, the usage may be monitored individually for different users of a device. Different users of a device can be identified depending on a user profile which is being used at the time when the function is activated, facial recognition of the user or the like. Therefore, even if multiple users share an audio-visual display device, it is possible to individually tailor the configuration of the device for each user.

In this way, the monitoring unit can monitor the usage of different functions of the audio-video display device by an individual user which enables the trained model to be more accurately tailored towards the requirements of an individual user (described in more detail below).

### <Determining Unit>

In addition, apparatus 3000 further comprises a determining unit 3012. The determining unit 3012 may be part of the processing unit 3008 of the information processing apparatus 3000. Furthermore, the determining unit 3012 is configured to determine a level of interest in the one or more functions of the information processing apparatus in accordance with the monitored usage of the information processing device.

As described, the monitoring unit 3010 of information processing apparatus 3000 monitors the usage of different functions of the audio-video display device by the user. This usage may include several different types of information, including a frequency of use, a context of use and a difficulty of use. The monitoring unit 3010 may, in some examples, continually monitor the usage of different functions by the user. As such, the monitored usage of the different functions for a user may change over time.

Nevertheless, at any given instance of time, the determining unit 3012 of the information processing apparatus 3000 may use the information from the monitoring unit 3010 (i.e. the monitored usage of the functions) in order to determine a level of interest of the one or more functions of the information processing apparatus for the user.

In some examples, the determining unit 3012 may determine the level of interest in the one or more functions of the information processing apparatus for the user based on a calculation of the probability of the user requiring a certain function of the audio-visual display device at a certain time. For example, based on the previous usage frequency of a function (such as Audio Description) the determining unit 3012 of information processing apparatus 3000 may determine that the level of interest of the user in that function (such as Audio Description) is high—indicating that there is a high probability that the user will try to activate that function again in the future.

The level of interest can be calculated in accordance with a number of different factors of the monitored usage of a given function by the user. For example, if the user struggles to activate a particular function (that is, if the monitored level of user difficulty for a given function is high) then an adaptation to assist the user should be made even when that function is not used as frequently as a different function which the user finds very easy to activate—provided that the usage of that function is above a predetermined threshold level. On the other hand, if the frequency of use of a function is very low (i.e. below a predetermined threshold level) then a certain degree of difficulty in activation of the function can be tolerated, since the user very rarely requires use of that function.

Therefore, the level of interest in a function calculated by the determining unit 3012 should be calculated in accordance with all aspects of the usage of the function which have been monitored by the monitoring unit, in order that adaptations to assist the user in activation of a function are made with respect to that function or those functions which are of most relevance to the user.

As a specific example of determining the level of interest, consider an example situation whereby a user activates a particular function of the audio-visual display device. If that function is often chosen (above a predetermined frequency threshold) and, optionally, if that function takes a long time for the user to activate (above a predetermined time duration threshold) then the level of interest the user has in that function should be set to be high, such that appropriate adaptations can be made in order for the user to more easily and accurately activate that feature in the future.

In this way the determining unit 3012 of the information processing apparatus 3000 can determine the level of interest the user has in a function or functions of the information processing apparatus, in accordance with the usage of that function as monitored by the monitoring unit of the information processing apparatus.

Once the level of interest has been calculated, this information is then passed to the adapting unit 3014 of the information processing apparatus 3000.

### <Adapting Unit>

The information processing apparatus 3000 further comprises an adapting unit 3014. The adapting unit 3014 may be part of the processing circuitry 3008 of the information processing apparatus 3000. The adapting unit 3014 of the information processing apparatus is configured to adapt the configuration of the information processing device, wherein adapting the configuration of the information processing device includes adapting a decision threshold of the trained model for determining a function to activate on the basis of the determined level of interest.

As explained, the control unit 3006 of the apparatus 3000 uses a trained model in order to determine a function of the functions stored in the storage unit 3004 of apparatus 3000 which should be activated. The trained model may be trained on historical data from a plurality of users and/or simulated training data. However, while the trained model may provide an efficient tool using which a user can activate certain functions of the information processing apparatus (to adapt the audio-visual content produced by the audio-visual device) it may still be difficult for a user to activate certain functions of the information processing apparatus.

Indeed, as previously explained, there are a number of different functions which may be stored in the storage unit 3006 of the apparatus 3000 which can be used to adapt the production of audio-visual content on the display device. Some of these functions may be used quite often by a user. However, other functions may be used very rarely by the user—if the user uses these functions at all. Moreover, the relative usage of the functions stored in the storage unit may vary between users of the audio-visual display device. For example, a user with a visual impairment may frequently require use of a function such as Audio Description, while a user with an auditory impairment may rarely use an Audio Description function at all. This makes it difficult for a trained model to decide when to activate a given function, as the relative usage of the functions may change significantly between users.

Accordingly, in embodiments of the disclosure, the adapting unit 3014 of the present disclosure is configured to adapt the configuration of the information processing device, including, in particular, adapting a decision threshold of the trained model for determining a function to activate on the basis of the determined level of interest of the user.

In this way, the trained model can be more accurately tailored towards the requirements of an individual user.

It will be appreciated that there are several different ways in which the decision threshold of the trained model for determining a function to activate can be adapted. However, in general, adaption of the decision threshold of the trained model such that the sensitivity to activating the function is reduced. That is, once the reduced threshold is applied, the particular function should be easier to activate. Thus, the trained model can be readily adapted to the specific requirements of an individual user.

In one example of the present disclosure, adapting the decision threshold may include reducing the sensitivity to activating a function of the one or more functions on the basis of the determined level of interest.

That is, the information processing apparatus 3000 may reduce the sensitivity to activating a function, thus making it more likely that the function will be activated by the trained model in response to the user input and the configuration of the information processing device. As an example, the information processing apparatus 3000 may reduce the sensitivity to activating a function (thus making it more likely that the function will be activated) by increasing a number of triggers associated with a function of the one or more functions.

Consider now FIG. 6A of the present disclosure. FIG. 6A illustrates an example of changing a decision threshold in accordance with embodiments of the disclosure. Changing a decision threshold is a specific example of changing a configuration of the information processing device.

In the example of FIG. 6A, a graph is shown illustrating a decision which may be taken by a trained model when activating a function.

The area under the graph 6000 shows all possible triggers which could be identified by the trained model for activating a given function F. The area under the between the vertical lines 6000A and 6000B indicate the subset of triggers which the trained model will accept for activating the function F once trained (i.e. at a first sensitivity level). The trained model may accept, by default, quite a narrow subset of all the possible triggers for the function. This corresponds to a first decision threshold. Only a trigger condition which falls within the narrow subset between 6000A and 6000B will activate the function.

By setting a narrow subset between 6000A and 6000B as the default trigger condition for all users, the trained model can reduce the likelihood of the function being activated unintentionally by a user (since the decision threshold for the function is high).

However, the level of interest which has been determined for a specific user (by monitoring the user's use of the functions) may indicate that the user uses certain functions very frequently or that the user experiences difficulty in activating that function. Therefore, the information processing apparatus 3000 may determine that the decision threshold should be adapted in order that the user can more easily activate the desired function.

Accordingly, the information processing apparatus 3000 may determine to apply a reduced decision threshold for a particular function, so that the sensitivity for activating that function is reduced. In particular, the information processing apparatus 3000 may increase the range of trigger conditions which can be accepted for activating the function (e.g. to a range between 6000C and 6000D). This means that a wider range of trigger conditions may be accepted by the trained model for activating that function—thus making it easier for the user to trigger the desired function.

The lower the decision threshold is set for a given function, the easier it becomes for the user to activate that given function. However, if the decision threshold is set too low for each function, then the likelihood of accidental activation of a function by a user will also increase.

Therefore, by adapting the decision threshold of the trained model for the individual functions in accordance with the use of those functions as has been monitored by the user, more accurate control to adapt the display of content on an audio-visual display device can be achieved with reduced complexity of operation. This reduces frustration of the user (e.g. through being unable to activate a desired function) and ensures that audio-visual content can be more easily accessible for all users including users with reduced mobility, reduced dexterity, an audio/visual impairment and/or cognitive impairment.

In other words, a higher decision threshold for activation of the functions may be preferable for most users (at least initially), which maintains a relative degree of difficulty or sensitivity to changing settings (preventing the user from accidentally activating functions). However, once the user's use of the functions has been monitored, the decision threshold of the trained model can be adapted in order to provide a personalisation of the trained model for the user which makes it easier for the user to activate certain functions.

In some examples of the disclosure, when it is determined that a function is of particular interest to the user, then the adapting unit 3014 may adapt the decision threshold of the trained model by applying an enhanced list of trigger keywords in voice detection. For example, when it is determined that the subtitles function is of particular interest to a user, the adapting unit 3014 may apply an enhanced list of trigger keywords including, “Text”, “Description”, “Writing” and “Subs”. Therefore, even though the user may not remember that the trigger keyword for activation of the subtitles function is (by default) “Subtitles”, they may nevertheless still easily and accurately activate the function by using any of the keywords from the enhanced list of trigger keywords.

Hence, in examples, the number of keywords that may trigger a certain function may be augmented in order to make it easier for the user to activate that function (e.g. an accessibility feature). Then, even if the user does not know or does not remember the specific default instruction required to activate that particular function, they are still able to activate the desired function with improved ease and accuracy.

Consider, now, the example of FIG. 6B of the present disclosure. FIG. 6B of the present disclosure illustrates an example of a voice instruction in accordance with embodiments of the disclosure.

In this example, a microphone (a type of input device) captures voice instructions provided by the user. A speech-to-text unit then converts the voice instruction provided by the user to a text command (thus generating a text string). This text string is provided to a natural language processor (an example of a trained model in accordance with embodiments of the disclosure).

The natural language processor then interprets the text string which is received in order to determine an action to perform (e.g. a function to activate).

The initial calibration of the natural language processor may be provided such that the natural language processor chooses an appropriate action to perform for most users. That is, the initial training of the natural language processor may be performed as previously described, such that the natural language processor is trained on the historical input instructions or simulated input instructions of a set of users.

However, while the initial configuration of the natural language processor may be satisfactory for most users, certain individual users may find it difficult to provide appropriate input instructions to activate a certain function on the apparatus. For example, a user with a visual impairment may frequently require use of a function such as Audio Description, while a user with an auditory impairment may rarely use an Audio Description function at all. This makes it difficult for a trained model to decide when to activate a given function, as the relative usage of the functions may change significantly between users.

Accordingly, in this example, the natural language processor receives information concerning accessibility function usage patterns (e.g. the functions most frequently used by the user) and accessibility function hints (e.g. the configuration of the device at the time when the accessibility function was activated, which thus hints towards the intended use of that function).

The natural language processor is then recalibrated on the basis of this information in order to reduce a decision threshold for activation of those accessibility functions, thus making it easier for a user to activate an intended accessibility function.

In this way, the trained model (here, the natural language processor) can be tailored toward the specific requirements of the user.

Alternatively or in addition, the adapting unit 3014 may adapt the decision threshold of the trained model by adaptively lowering the threshold for some specific words in case they are misspoken, or spoken by someone with a speech impediment.

Alternatively or in addition, the adapting unit 3014 may adapt the decision threshold of the trained model by requesting fresh training of voice commands data from the user. In particular, the adapting unit 3014 may request that the user performs a specific calibration for a particular function or set of functions, in order that the trained model can be adapted more specifically to the individual user. A lower decision threshold (based on the specific calibration performed by the user) may then be applied, making it easier for the user to activate those functions. Retraining of the trained model on the calibration data provided by the user can be performed in the same way as described for initial training of the trained model as previously described, taking the calibration data provided by the user as the training data for the trained model.

Hence, in some examples, the adapting unit 3014 may prompt the use to re-train the neural network to the user's specific voice for certain specific functions or requests.

Often, once certain functions have been activated (for example, once accessibility settings have been set), it may be difficult for the user to reset or reactivate those functions at a later time. In particular, the user may wish that accidental changes are not made once a desired function has been activated. Accordingly, in some examples, once a UI, or indeed a sequence of voice commands is to a user's liking, selected parts may be fixed in memory so that an future retraining does not change the user experience drastically such that they cannot find the desired function, thus further improving the user's experience when controlling the device.

Indeed, in some examples, the processing unit 3008 of the information processing apparatus 3000 may be configured to maintain a result of activation of a function, once activated, until occurrence of a predetermined event. In examples, the predetermined event may include the user performing a specific sequence of inputs in order to override or cancel the activation of the function. An example is input of a personal identification number (PIN). This ensures that the user cannot accidentally cancel activation of a function of the device, thus reducing user frustration.

Alternatively or in addition, one or more settings of the trained model may be adapted in order to make it easier for a user to select a desired function in accordance with the determined level of interest of the user. For example, certain settings may be changed in order to give the user longer to perform an input operation or to select options when trying to activate a desired function. More generally, the configuration of the information processing device may be adapted in accordance with embodiments of the disclosure.

Consider, now FIG. 7 of the present disclosure. FIG. 7 illustrates an example of adapting a configuration of the information processing device in accordance with embodiments of the disclosure.

In this specific example, the specific configuration of the information processing device includes a structure of a menu provided to the user. The menu may be provided as part of a graphical user interface (GUI) which the user can use in order to select one or more functions of the information processing device. Alternatively, the menu may be provided as part of a talking user interface, which the user can use in order to select one or more functions of the information processing device. The present disclosure is not particularly limited in this regard.

In this example, the trained model (used, by the control unit, to determine one or more functions of the information processing apparatus to activate) is based on a neural network 7000. The neural network may have been trained on training data as previously described. Accordingly, the neural network will take a user input and the current configuration of the information processing device and determine, for those inputs, a function which should be activated.

The initial settings of the menu structure used by the user in order to provide input in this example are defined based on the default settings (or initial settings) 7002.

As the user operates the information processing apparatus, the monitoring unit 3010 of the information processing apparatus is configured to monitor the usage of the menu 7004 by the user.

For example, the monitoring unit 3010 may be configured to monitor how frequently a user selects a certain option in the menu (corresponding to a particular function) how long a user takes to navigate through the menu to find a desired option within the menu or the like. The menu usage is then provided to the neural network 7000.

From the monitored usage of the menu (and the functions activated by the user) the information processing apparatus 3000 may determine that the user has a particular level of interest in a certain set of functions (such as accessibility functions). Alternatively or in addition, the information processing apparatus 3000 may determine that the user finds it difficult to activate certain functions.

The processing circuitry of the information processing apparatus 3000 may then adapt the configuration of the information processing device (here, the menu structure) in order to make it easier for the user to activate a desired function on the basis of the determined level of interest the user has in a certain function.

For example, the menu structure may be adapted such that a certain category of accessibility functions (e.g. auditory accessibility functions) are brought together under one menu item. Alternatively, or in addition, the information processing apparatus may be configured to produce a list of favourite accessibility settings, which could implement a macro (multiple steps) to set up a function as required. Further alternatively, or in addition, the information processing apparatus may be configured to adapt the menu structure by gathering shortcuts or menu items to relevant accessibility features to a location on screen or in a menu hierarchy that is easy to find customised for a particular user or group of users.

Hence, in examples, adapting the configuration of the information processing device further a menu of functions displayed to the user, wherein the control unit is configured to determine a function to activate from the menu of functions displayed to the user. This makes it easier for a user to activate a desired function of the information processing device. Indeed, as the menu structure required to access certain functions is simplified for the user (such that fewer user input instructions, such as button presses or the like are required), it becomes easier for a user who suffers from reduced mobility (or dexterity) to activate a desired function.

Furthermore, in some examples, the information processing apparatus 3000 may be configured in order to provide a level of feedback to the user when executing a function in accordance with the decision threshold for execution of that function of the one or more functions.

As explained, in some examples activating a function includes offering or suggesting that function to the user prior to executing that function. Accordingly, in some examples, the user may have a predetermined amount of time to reject the function which has been offered before that function is executed (e.g. before a predetermined timer expires).

When the decision threshold for activating a certain function is reduced (based, for example, on the usage of a user) then that function will be more readily activated and offered to the user. For example, a subtitles function may be activated and offered to the user every time that the user activates a particular television streaming service on their television.

Accordingly, in examples, the information processing apparatus 3000 may provide enhanced feedback to the user when activating a function for which the decision threshold has been reduced.

As an example, a message offering that function to the user may be provided in a different font colour, in a different font size, or with a different audio sound. The enhanced level of feedback makes it easier for the user to identify that said function has been activated and therefore makes it easier to cancel the activation of the application.

As such, the provision of feedback to the user at a level of feedback in accordance with the decision threshold for execution of that function ensures that a user can more easily cancel an activation of a function when that function is more easily activated, thus ensuring that unintentional triggers of the function do not increase frustration for the user.

In this way, the adapting unit 3014 adapts the configuration of the information processing apparatus 3000 (including adapting the decision threshold of the trained model) thus making it easier for a user to more accurately activate a desired function of the information processing device.

### Advantageous Technical Effects

In accordance with embodiments of the disclosure, the information processing apparatus adapts a decision threshold of the trained model in order to tailor the trained model specifically to the requirements of the user—thus making it easier for a user to activate a desired function or set of functions from amongst those functions stored in the storage unit.

In particular, with the information processing apparatus 3000 of the present disclosure, more accurate control to adapt the display of content on an audio-visual display device can be achieved with reduced complexity of operation. This reduces frustration of the user and ensures that audio-visual content can be more easily accessible for all users including users with reduced mobility, reduced dexterity, an audio/visual impairment and/or cognitive impairment.

The present disclosure is not particularly limited to these advantageous technical effects. Other advantageous technical effects will become apparent to the skilled person when reading the disclosure.

### <Method>

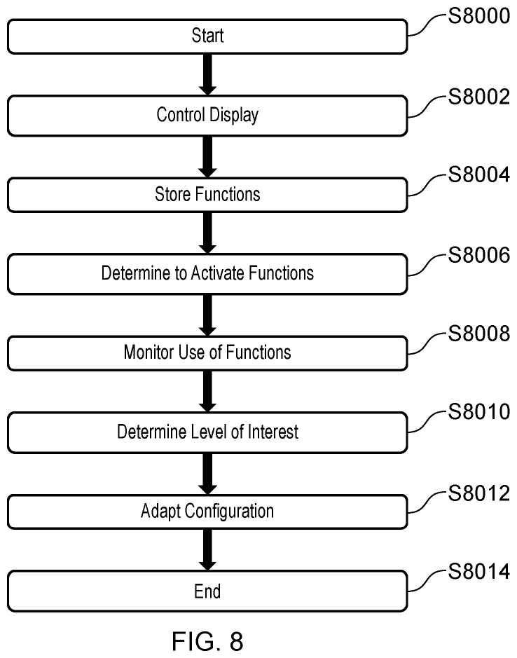

Hence, more generally, a method for an information processing apparatus (or device) is provided in accordance with embodiments of the disclosure. An example method is illustrated in FIG. 8 of the present disclosure.

The method starts in step S8000 and proceeds to step S8002.

In step 8002, the method comprises controlling, with a display control unit of the information processing apparatus, an audio-visual display device to provide audio-visual content to a user.

The method then proceeds to step S8004.

In step S8004, the method comprises storing, in a storage unit of the information processing apparatus, one or more functions which can be activated by the information processing apparatus to adapt the provision of audio-visual content.

The method then proceeds to step S8006.

In step S8006, the method comprises using, with a control unit of the information processing apparatus, a trained model to determine to activate at least one of the one or more functions of the information processing apparatus in accordance with a received user input and a configuration of the information processing apparatus.

The method then proceeds to step S8008.

In step S8008, the method comprises monitoring, with a processing unit of the information processing apparatus, usage of the information processing apparatus by the user, including monitoring usage of the one or more functions of the information processing apparatus.

Then, the method proceeds to step S8010.

In step S8010, the method comprises determining, with the processing unit of the information processing apparatus, a level of interest in the one or more functions of the information processing apparatus in accordance with the monitored usage of the information processing apparatus.

The method then proceeds to step S8012.

In step S8012, the method comprises adapting, with the processing unit of the information processing apparatus, the configuration of the information processing apparatus, wherein adapting the configuration of the information processing apparatus includes adapting a decision threshold of the trained model for determining a function to activate on the basis of the determined level of interest.

The method then proceeds to and ends with step S8014.

It will be appreciated that the method for an information processing apparatus in accordance with embodiments of the present disclosure is not particularly limited to the example illustrated with reference to FIG. 8. In particular, the steps of the method may be performed in an order different to that illustrated in FIG. 8. For example, a number of these steps may be performed in parallel.

### Further Embodiments

The information processing device may include computer code components representing a pre-stored indexed electronic instruction manual or operation guide which a user can actuate, for example by a function button on the remote control to output to the display. The instruction manual may be a webpage or collection of webpages and written in structured code, such as html or other markup language. It may be searchable. It may contain screenshot images or other representations of particular functions. The functions may be accessibility functions (including, for example, subtitles).

In examples, the information processing device may be configured to change portions of the indexed instruction manual according to how the information processing device has adapted its configuration. The portions may be aligned to appropriate positions in the indexing. This makes it easier for the user to navigate the operation guide even when the configuration of the information processing device has been adapted. Accordingly, in examples, the disclosure provides:

An information processing device, comprising circuitry configured to:
control an audio-visual display device to provide audio-visual content to a user;
store one or more functions which when activated by the information processing device, adapt the production of audio-visual content;
use a trained model to determine to activate at least one of the one or more functions of the information processing device in accordance with a received user input and a configuration of the information processing device; and
the circuitry being further configured to:
   monitor usage of the information processing device by the user, including monitoring usage of the one or more functions of the information processing device;
   determine a level of interest in the one or more functions of the information processing device in accordance with the monitored usage of the information processing device; and
adapt the configuration of the information processing device;
store data representing the adaptions of the information processing device; and

insert the stored data into data representing an electronic operation guide stored in non-transitory storage medium.

A corresponding method and computer program is also within the scope of the disclosure.

Furthermore, it will be appreciated that the disclosure is not limited functions which may be considered to be functions of the operating system of the information processing device.

In examples, the information processing device may run applications such as a catch-up television service, IPTV application or other interactive application. These may be natively installed on the information processing device for example at the point of manufacture or may be later downloaded and launched on the information processing device (e.g. from an app store, portal or the like). In examples, the application may be an HbbTV application. The application may be obtained via download from a server, the information processing device connecting to the server for example via the internet. The application may be provided in a broadcast transmission.

Such applications may have their own accessibility settings and features. A user is able to configure them from within a user interface available for example under a settings option. Such applications may include an interface such as an API (Application Programming Interface) through which settings may be controlled. Accessibility settings may be controlled in this way, such that if for example subtitles are enabled on a television device, then when a user launches a catch-up TV application, the subtitles settings from the television device are also applied to the settings of the application.

The principle can also apply in reverse such that settings from the application are applied to the television device. As such, the configuration of the application running on the television device may be adapted by adapting a decision threshold of the trained model for determining a function to activate on the basis of the determined level of interest.

In addition, the configuration of a television device may be adapted by adapting a decision threshold of the trained model for determining a function to activate on the basis of the determined level of interest in the functions of an application.

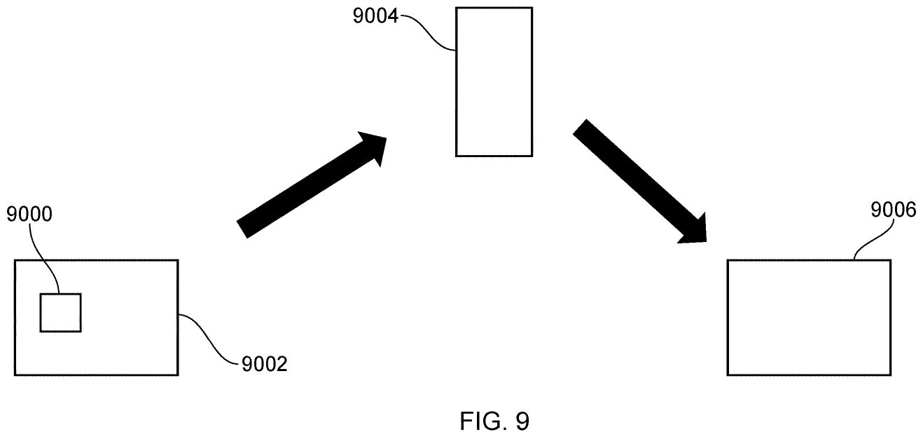

Consider, now, FIG. 9 of the present application. FIG. 9 illustrates an example of adapting the configuration of an information processing device in accordance with embodiments of the disclosure.

In this example, a user has installed an application 9000 on a first information processing device 9002. The application may have been installed on the first information processing device from an app store, portal or the like. However, in other examples, the application may have been pre-installed at least initially and subject to software update on the first information processing device.

In accordance with embodiments of the disclosure, the configuration of the application running on the first information processing device may be adapted by adapting a decision threshold of a trained model for determining a function to activate on the basis of the determined level of interest. For example, the configuration of the application may be adapted such that it is easier for the user to activate a certain accessibility function when using the application.

In this example, the first information processing device 9002 is a television device.

Furthermore, in this example, the adapting of the decision threshold may be computed on a server 9004 for an application and communicated to the television device 9002 via a communications network (such as the internet or the like).

Then, if a user launches or downloads the application to a second device 9006 by logging on to a server 9004, the adapted decision threshold stored on the server 9004 in association with that application and a user's credentials may be used on the second device 9006. Therefore the configuration of the application on the second device is adapted based on the settings from the application running on the first device 9002. This makes it easier for the user to access accessibility functions on the application, even when changing between different devices. Similarly, in embodiments, if the first device requires or optionally suggests that the application can be updated, then the adapted decision threshold may be retrieved from the server, or if stored on the first devices, from memory of the first device and applied to the updated application stored on the first device.

In some examples, the second device may also be a television device. In other examples, the second device may be a portable electronic device (such as a mobile phone, tablet computing device, laptop computing device, or the like).

In examples, the second device's configuration is adapted upon execution of the application on the second device if the user downloads the application using the same credentials.

Furthermore, embodiments of the present disclosure can be arranged in accordance with the following numbered clauses:
1. An information processing device, comprising:
   a display control unit configured to control an audio-visual display device to provide audio-visual content to a user;
   a storage unit configured to store one or more functions which can be activated by the information processing device to adapt the production of audio-visual content;
   a control unit configured to use a trained model to determine to activate at least one of the one or more functions of the information processing device in accordance with a received user input and a configuration of the information processing device; and
   a processing unit configured to:
      monitor usage of the information processing device by the user, including monitoring usage of the one or more functions of the information processing device;
      determine a level of interest in the one or more functions of the information processing device in accordance with the monitored usage of the information processing device; and
      adapt the configuration of the information processing device, wherein adapting the configuration of the information processing device includes adapting a decision threshold of the trained model for determining a function to activate on the basis of the determined level of interest.
2. The information processing device according to clause 1, wherein the one or more functions include accessibility functions for the display of the audio-visual content to the user.
3. The information processing device according to clause 2, wherein the accessibility functions include at least one of: a function to adapt the provision of audio-visual content to include subtitles, a function to adapt the provision of audio-visual content to include a sign language video, a function to adapt the provision of audio-visual content to include a talking user interface, a function to adapt the provision of audio-visual content to include Text-to-Speech and/or a function to adapt the provision of audio-visual content to include Audio Description.
4. The information processing device according to any preceding clause, wherein the trained model includes a machine learning model.
5. The information processing device according to clause 4, wherein the machine learning model is a deep learning model based on neural networks.
6. The information processing device according to any preceding clause, wherein the usage of the one or more functions includes at least one of: a frequency of use, a context of use, a time of use and/or a difficulty of use by the user.
7. The information processing device according to clause 6, wherein the difficulty includes a number of received user inputs prior to execution of the function and/or a time duration from an initial user input prior to execution of the function to the execution of the function.
8. The information processing device according to any preceding clause, wherein adapting the configuration further includes adapting a menu of functions displayed to the user, wherein the control unit is configured to determine a function to activate from the menu of functions displayed to the user.
9. The information processing device according any preceding clause, wherein adapting the decision threshold of the control unit includes re-training the trained model using specific training data acquired from the user.
10. The information processing device according to any preceding clause, wherein adapting the decision threshold includes reducing the sensitivity to activating a function of the one or more functions on the basis of the determined level of interest.
11. The information processing device according to clause 10, wherein reducing the sensitivity includes increasing a number of triggers associated with a function of the one or more functions.
12. The information processing device according to any preceding clause, wherein the processing unit is further configured to provide a level of feedback to the user when executing a function in accordance with the decision threshold for execution of that function of the one or more functions.
13. The information processing device according to any preceding clause, wherein the processing unit is configured to maintain a result of activation of a function, once activated, until occurrence of a predetermined event.
14. The information processing device according to any preceding clause, wherein the information processing device is configured to run one or more applications of the information processing device for output of audio video content.
15. The information processing device according to clause 14, wherein the one or more applications of the information processing device are stored in the storage unit.
16. The information processing device according to clause 14, wherein the audio video content to be provided to the user is output by one of the one or more applications of the information processing device.
17. The information processing device according to clause 14, wherein monitoring usage of the information processing device includes monitoring usage of one or more of the one or more applications of the information processing device.
18. The information processing device according to clause 14, wherein adapting the configuration of the information processing device includes adapting a configuration of one or more of the one or more applications of the information processing device.
19. The information processing device according to clause 18, wherein the information processing device is configured to store the configuration of the one or more applications of the information processing device in a server in association with user credentials; and wherein the information processing device is configured to download a configuration of the one or more applications of the information processing device from the server in accordance with the credentials of the user.
20. A method for an information processing device, the method comprising:
   controlling, with a display control unit of the information processing apparatus, an audio-visual display device to provide audio-visual content to a user;
   storing, in a storage unit of the information processing apparatus, one or more functions which can be activated by the information processing apparatus to adapt the provision of audio-visual content;
   using, with a control unit of the information processing apparatus, a trained model to determine to activate at least one of the one or more functions of the information processing apparatus in accordance with a received user input and a configuration of the information processing apparatus;
   monitoring, with a processing unit of the information processing apparatus, usage of the information processing apparatus by the user, including monitoring usage of the one or more functions of the information processing apparatus;
   determining, with the processing unit of the information processing apparatus, a level of interest in the one or more functions of the information processing apparatus in accordance with the monitored usage of the information processing apparatus;
   adapting, with the processing unit of the information processing apparatus, the configuration of the information processing apparatus, wherein adapting the configuration of the information processing apparatus includes adapting a decision threshold of the trained model for determining a function to activate on the basis of the determined level of interest.
21. A computer program comprising instructions which, when implemented by a computer, cause the computer to perform a method for an information processing device, the method comprising:
   controlling, with a display control unit of the information processing apparatus, an audio-visual display device to provide audio-visual content to a user;
   storing, in a storage unit of the information processing apparatus, one or more functions which can be activated by the information processing apparatus to adapt the provision of audio-visual content;
   using, with a control unit of the information processing apparatus, a trained model to determine to activate at least one of the one or more functions of the information processing apparatus in accordance with a received user input and a configuration of the information processing apparatus;
   monitoring, with a processing unit of the information processing apparatus, usage of the information processing apparatus by the user, including monitoring usage of the one or more functions of the information processing apparatus;
   determining, with the processing unit of the information processing apparatus, a level of interest in the one or more functions of the information processing apparatus in accordance with the monitored usage of the information processing apparatus;
adapting, with the processing unit of the information processing apparatus, the configuration of the information processing apparatus, wherein adapting the configuration of the information processing apparatus includes adapting a decision threshold of the trained model for determining a function to activate on the basis of the determined level of interest.
22. A non-transient computer readable storage medium comprising the computer program according to clause 21.
23. An information processing device, comprising circuitry configured to:
   control an audio-visual display device to provide audio-visual content to a user;
   store one or more functions which when activated by the information processing device, adapt the production of audio-visual content;
   use a trained model to determine to activate at least one of the one or more functions of the information processing device in accordance with a received user input and a configuration of the information processing device; and
   the circuitry being further configured to:
      monitor usage of the information processing device by the user, including monitoring usage of the one or more functions of the information processing device;
      determine a level of interest in the one or more functions of the information processing device in accordance with the monitored usage of the information processing device; and
      adapt the configuration of the information processing device, wherein adapting the configuration of the information processing device includes adapting a decision threshold of the trained model for determining a function to activate on the basis of the determined level of interest.

Numerous modifications and variations of the present disclosure are possible in light of the above teachings. It is therefore to be understood that within the scope of the appended claims, the disclosure may be practiced otherwise than as specifically described herein.

In so far as embodiments of the disclosure have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present disclosure.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed, the functionality may be implemented in a single unit, in a plurality of units, or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

1. An information processing device, comprising circuitry configured to:
control an audio-visual display device to provide audiovisual content to a user;
storage unit configured to store one or more functions which can be activated by the information processing device to adapt the production of audio-visual content;
use a trained model to determine to activate at least one of the one or more functions of the information processing device in accordance with a received user input and a configuration of the information processing device; and
the circuitry being further configured to:
monitor usage of the information processing device by the user, including monitoring usage of the one or more functions of the information processing device;
determine a level of interest in the one or more functions of the information processing device in accordance with the monitored usage of the information processing device; and
adapt the configuration of the information processing device, wherein adapting the configuration of the information processing device includes adapting a decision threshold of the trained model for determining a function to activate on the basis of the determined level of interest.

2. The information processing device according to claim 1, wherein the one or more functions include accessibility functions for the display of the audio-visual content to the user.

3. The information processing device according to claim 2, wherein the accessibility functions include at least one of: a function to adapt the provision of audio-visual content to include subtitles, a function to adapt the provision of audio-visual content to include a sign language video, a function to adapt the provision of audio-visual content to include a talking user interface, a function to adapt the provision of audio-visual content to include Text-to-Speech and/or a function to adapt the provision of audio-visual content to include Audio Description.

4. The information processing device according to claim 1, wherein the trained model includes a machine learning model.

5. (canceled)

6. The information processing device according to claim 1, wherein the usage of the one or more functions includes at least one of: a frequency of use, a context of use, a time of use and/or a difficulty of use by the user.

7. The information processing device according to claim 6, wherein the difficulty includes a number of received user inputs prior to execution of the function and/or a time duration from an initial user input prior to execution of the function to the execution of the function.

8. The information processing device according to claim 1, wherein adapting the configuration further includes adapting a menu of functions displayed to the user, wherein the circuitry is configured to determine a function to activate from the menu of functions displayed to the user.

9. The information processing device according to claim 1, wherein adapting the decision threshold of the circuitry includes re-training the trained model using specific training data acquired from the user.

10. The information processing device according to claim 1, wherein adapting the decision threshold includes reducing the sensitivity to activating a function of the one or more functions on the basis of the determined level of interest.

11. The information processing device according to claim 10, wherein reducing the sensitivity includes increasing a number of triggers associated with a function of the one or more functions.

12. The information processing device according to claim 1, wherein the circuitry is further configured to provide a level of feedback to the user when executing a function in accordance with the decision threshold for execution of that function of the one or more functions.

13. The information processing device according to claim 1, wherein the circuitry is configured to maintain a result of activation of a function, once activated, until occurrence of a predetermined event.

14. The information processing device according to claim 1, wherein the information processing device is configured to run one or more applications of the information processing device for output of audio video content.

15. The information processing device according to claim 14, wherein the one or more applications of the information processing device are stored in memory of the information processing device.

16. The information processing device according to claim 14, wherein the audio video content to be provided to the user is output by one of the one or more applications of the information processing device.

17. The information processing device according to claim 14, wherein monitoring usage of the information processing device includes monitoring usage of the one or more applications of the information processing device.

18. The information processing device according to claim 14, wherein adapting the configuration of the information processing device includes adapting a configuration of the one or more applications of the information processing device.

19. The information processing device according to claim 18, wherein the information processing device is configured to store the configuration of the one or more applications of the information processing device in a server in association with user credentials; and wherein the information processing device is configured to download a configuration of the one or more applications of the information processing device from the server in accordance with the credentials of the user.

20. A method, comprising:
controlling an audiovisual display device to provide audio-visual content to a user;
storing one or more functions which can be activated by an information processing apparatus to adapt the provision of audiovisual content;
using a trained model to determine to activate at least one of the one or more functions of the information processing apparatus in accordance with a received user input and a configuration of the information processing apparatus;
monitoring usage of the information processing apparatus by the user, including monitoring usage of the one or more functions of the information processing apparatus;
determining a level of interest in the one or more functions of the information processing apparatus in accordance with the monitored usage of the information processing apparatus;
adapting the configuration of the information processing apparatus, wherein adapting the configuration of the information processing apparatus includes adapting, by circuitry, a decision threshold of the trained model for determining a function to activate on the basis of the determined level of interest.

21. A non-transitory computer readable storage medium comprising instructions which, when implemented by a computer, cause the computer to perform a method comprising:
controlling an audiovisual display device to provide audio-visual content to a user;
storing one or more functions which can be activated by an information processing apparatus to adapt the provision of audiovisual content;
using a trained model to determine to activate at least one of the one or more functions of the information processing apparatus in accordance with a received user input and a configuration of the information processing apparatus;
monitoring usage of the information processing apparatus by the user, including monitoring usage of the one or more functions of the information processing apparatus;
determining a level of interest in the one or more functions of the information processing apparatus in accordance with the monitored usage of the information processing apparatus;
adapting the configuration of the information processing apparatus, wherein adapting the configuration of the information processing apparatus includes adapting a decision threshold of the trained model for determining a function to activate on the basis of the determined level of interest.

22. (canceled)
